(19) United States
(12) Patent Application Publication
(10) Pub. No.: US 2016/0306438 A1
(43) Pub. Date: Oct. 20, 2016

(54) PHYSICAL AND VIRTUAL INPUT DEVICE INTEGRATION

(71) Applicant: Logitech Europe S.A., Lausanne (CH)

(72) Inventors: Aidan Kehoe, Cork (IE); Jan Findlater, Cork (IE); Damien O'Sullivan, Cork (IE); Andreas Connellan, County Galway (IE); Erik Guack, Hsinchu City (TW); Vilasinh Vilaylack, Prevessin-Moens (FR); Sergiy Lavrenko, San Francisco, CA (US); Denis O'Keeffe, Cork (IE)

(21) Appl. No.: 15/099,519

(22) Filed: Apr. 14, 2016

Related U.S. Application Data
(60) Provisional application No. 62/147,577, filed on Apr. 14, 2015.

(51) Int. Cl. G06F 3/02; G06F 3/023; G06F 3/0482; G06F 3/0484; G06F 3/0481; G06F 3/041; G06F 3/0488

(52) U.S. Cl. CPC G06F 3/0227; G06F 3/0412; G06F 3/0237; G06F 3/04886; G06F 3/04842; G06F 3/04817; G06F 3/0482; G06F 3/04883

(57) ABSTRACT

An input device comprising a housing, a plurality of physical keys disposed in the housing, and a processor to generate an output signal in response to one of the plurality of physical keys being activated, and control an operation of one or more virtual keys displayed on a touch-sensitive display, the physical keys and the one or more virtual keys configured for concurrent operation. The processor can be further configured to communicate with a software application operating on the touch-sensitive display and control a selection of the one or more virtual keys based on features of the software application. In some embodiments, the virtual keys can be one or more emojis. The emojis can include a context specific emoji corresponding to at least a portion of a recently input word or phrase on the plurality of physical keys, trending emojis associated with a social media platform, and more.

### CROSS-REFERENCES TO RELATED APPLICATIONS

This application is a non-provisional application and claims the benefit and priority of U.S. Provisional Application No. 62/147,577, filed on Apr. 14, 2015, titled “PHYSICAL AND VIRTUAL INPUT DEVICE INTEGRATION,” which is hereby incorporated by reference in its entirety for all purposes.

### SUMMARY

Embodiments of the invention relate to systems and methods for integrating physical input devices with virtual input devices displayed on a touch-sensitive screen. In some implementations, a physical input device (keyboard) is physically and communicatively paired with a computing device having a touch-sensitive display. The touch sensitive display can display a virtual keyboard having a number of characters, emoji, predictive word selections, and more, along the edge of the touch-sensitive display nearest to the physical keyboard such that more input options are effectively at the users disposal—that is, buttons from the physical keyboard and virtual buttons or keys on the touch sensitive display are all at a user's finger tips for a more efficient and richer user interface (UI).

In certain embodiments, an input device includes a housing, a plurality of physical keys disposed in the housing, and a processor to generate an output signal in response to one of the plurality of physical keys being activated, and control an operation of one or more virtual keys displayed on a touch-sensitive display, the physical keys and the one or more virtual keys configured for concurrent operation. The processor can be further configured to communicate with a software application operating on the touch-sensitive display and control a selection of the one or more virtual keys based on features of the software application. In some embodiments, the virtual keys can be one or more emojis. The emojis can include a context specific emoji corresponding to at least a portion of a recently input word or phrase on the plurality of physical keys, trending emojis associated with a social media platform, recently used emojis, as well as a second set of emojis dynamically generated in response to a selection of a first emoji, where the second set of emojis contextually related to the first emoji.

In some embodiments, the one or more virtual buttons can include one or more function keys or predictive words or phrases corresponding to an input on the plurality of physical keys. The plurality of physical keys can include a key to enable and disable the one or more virtual keys. The processor can be configured to control an aesthetic presentation of the virtual keys including a color scheme.

In further embodiments, a method of operating an input device includes generating, by a processor, an output signal corresponding to an activation of one or more physical keys on the input device, sending, by the processor, the output signal to a second input device having a touch-sensitive display, sending a control signal, by the processor, to generate and display a virtual key on the touch-sensitive display, and controlling an operation of the virtual key displayed on a touch-sensitive display, where the physical key and the virtual key are concurrently operable.

In some implementations, the method includes associating an emoji with the virtual key. The emoji can be a context specific emoji corresponding to at least a portion of a recently input word or phrase output by the input device. The method may include determining a context of the first emoji based on at least a portion of a recently input word or phrase output by the input device, generating a second control signal, by the processor, configured to generate and display a second virtual key on the touch-sensitive display, and associating a second emoji with the second virtual key, wherein the second emoji is related to the first emoji based on the context of the first emoji. The emoji can a top trending emoji on a social media platform or a recently used emoji. The virtual key can include a predictive word or phrase corresponding to an output of the input device.

In some embodiments, the method includes receiving an input corresponding to an activation of an on/off key on the input device, generating, by the processor, a second output signal corresponding to the activation of an on/off key, and sending the second output signal to the second input device, wherein the second output signal successively enables and disables the virtual key. The method may further include controlling an aesthetic presentation of the virtual keys including a color scheme based on aspects and/or metadata of/from the input device.

In certain embodiments, a method includes displaying a virtual keyboard having a plurality of keys on a touch-sensitive display, receiving an input signal corresponding to a selection of at least one of the plurality of keys on the virtual keyboard, receiving an output signal from a peripheral input device having a plurality of keys, and generating and displaying an output on the touch-sensitive display corresponding to the input signal and output signal. The processor concurrently displays the virtual keyboard, processes and displays data associated with the input signal in the displayed output, and processes and displays data associated with the output signal in the displayed output.

In some embodiments, the method includes associating an emoji with the virtual keyboard. The emoji can be context specific and may correspond to at least a portion of a recently input word or phrase output by the peripheral input device. The emoji can be a top trending emoji on a social media platform or a recently used emoji. In some cases, the virtual keyboard includes a selectable predictive word or phrase corresponding to a recently input word or phrase output by the peripheral input device.

In further embodiments, the method includes receiving, by the processor, a second output signal corresponding to the activation of an on/off key on the peripheral input device, and enabling or disabling the virtual keyboard in response to receiving the second output signal. The method can further include controlling an aesthetic presentation of the virtual keyboard including a color scheme based on metadata received from the peripheral input device.

### BRIEF DESCRIPTION OF THE DRAWINGS

FIG. 1 illustrates a physical keyboard physically and communicatively coupled to a tablet computer, according to certain embodiments.

FIG. 2 illustrates an expanded view of a utility bar on a tablet computer physically and communicatively coupled to a physical keyboard, according to certain embodiments.

FIGS. 3A and 3B illustrate how a software application creates a seamless integration of physical and virtual input devices, according to certain embodiments.

FIG. 4A illustrates a static scrollable on-screen keyboard, according to certain embodiments.

FIG. 4B illustrates a static scrollable on-screen keyboard including one or more words, according to certain embodiments.

FIG. 5 shows a modifier key that can dynamically change the format of the on-screen keyboard, according to certain embodiments.

FIG. 6 illustrates use of a key on the physical keyboard to amplify media on the on-screen keyboard, according to certain embodiments.

FIG. 7 illustrates an integrated user interface, according to certain embodiments.

FIG. 8 illustrates an implementation that provides for bilingual virtual text and virtual emoji entry, according to certain embodiments.

FIG. 9 is a system diagram for displaying an on-screen virtual keyboard on a touch-sensitive display, according to certain embodiments.

FIG. 10 is a simplified flowchart illustrating a method of generating a virtual keyboard on a display that corresponds with and operates in conjunction with a physical keyboard, according to certain embodiments.

FIG. 11 is a simplified method of operating a keyboard and a mobile device, according to an embodiment of the present invention.

FIG. 12 is a simplified flowchart illustrating a method of displaying a virtual keyboard on a touch-sensitive display, according to an embodiment of the present invention.

FIG. 13 illustrates a simplified representation of a computer system for generating and controlling a virtual keyboard, according to certain embodiments.

### DETAILED DESCRIPTION

Embodiments of the invention relate to systems and methods for integrating physical input devices with virtual input devices displayed on a touch-sensitive screen. In some implementations, a physical input device (keyboard) is physically and communicatively paired with a computing device having a touch-sensitive display. The touch sensitive display can display a virtual keyboard having a number of characters, emoji, predictive word selections, and more, along the edge of the touch-sensitive display nearest to the physical keyboard such that more input options are effectively at the users disposal. That is, buttons from the physical keyboard and virtual buttons or keys on the touch sensitive display are all at a user's finger tips for a more efficient and richer user interface (UI), making for smart, adaptive, context aware input devices with the fusion of virtual and physical components.

Some embodiments relate to an input device (e.g., keyboard) communicatively coupled to a tablet or smart device having a touch-sensitive display. The keyboard can include a housing, a plurality of physical keys disposed in the housing, and a processor to generate an output signal in response to one of the plurality of physical keys being activated, and control an operation of one or more virtual keys displayed on the touch-sensitive display, the physical keys and the one or more virtual keys configured for concurrent operation. The processor can be further configured to communicate with a software application operating on the touch-sensitive display and control a selection of the one or more virtual keys based on features of the software application. In some embodiments, the virtual keys can be one or more emojis. The emojis can include a context specific emoji corresponding to at least a portion of a recently input word or phrase on the plurality of physical keys, trending emojis associated with a social media platform, recently used emojis, as well as a second set of emojis dynamically generated in response to a selection of a first emoji, where the second set of emojis contextually related to the first emoji.

Certain embodiments relate to a computing device having a touch-sensitive display that can perform a method that includes displaying a virtual keyboard having a plurality of keys on a touch-sensitive display, receiving an input signal corresponding to a selection of at least one of the plurality of keys on the virtual keyboard, receiving an output signal from a peripheral input device having a plurality of keys, and generating and displaying an output on the touch-sensitive display corresponding to the input signal and output signal. The processor concurrently displays the virtual keyboard, processes and displays data associated with the input signal in the displayed output, and processes and displays data associated with the output signal in the displayed output.

It should be noted that the embodiments described herein are not all-inclusive. Any input device or computing device with a display can utilize the inventive concepts described herein. Although this document primarily focuses on keyboards (i.e., more broadly—input devices) and tablet computers, it should be understood that the IP can cover fablets, desktops, living room keyboards (i.e., all keyboards), smart phones, smart watches, and the like.

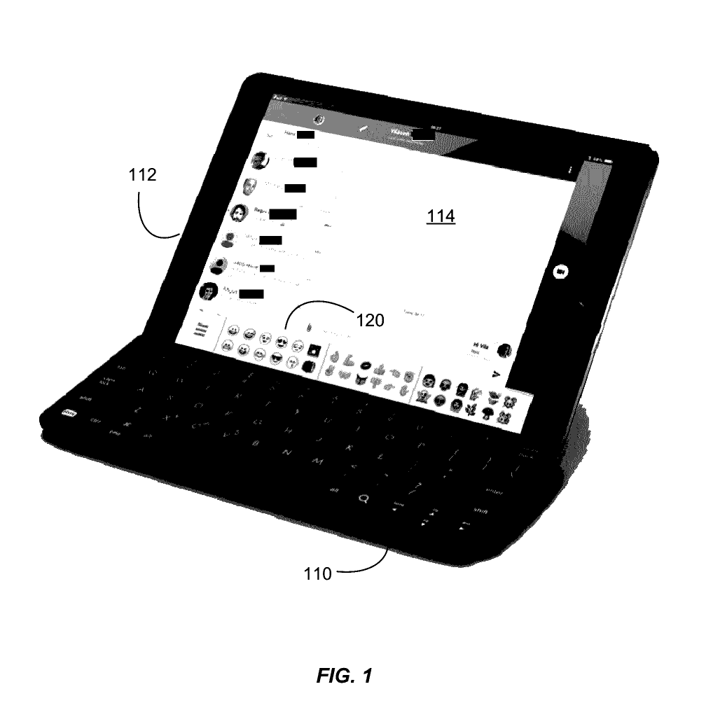

FIG. 1 illustrates a physical keyboard physically and communicatively coupled to a tablet computer, according to certain embodiments of the invention. As illustrated in FIG. 1, a physical keyboard 110 is physically and communicatively coupled to a tablet computer 112. The tablet computer 112 includes a screen 114 provides display functionality that includes a utility bar 120 featuring various icons including emoji. The list is dynamic and curated, aware of user inputs and their context, includes recently used emoji, emoji predictively generated from what was typed, trending emoji in social media (e.g., following musical artists, holidays, events, etc.), and the like. The utility bar 120, which can also be referred to as an “emoji bar,” an on-screen keyboard (OSK), or a virtual keyboard, has minimal impact on the screen (i.e., the footprint is small in comparison to the total size of the screen, and includes many optimal and curated choices at the user's fingertips.

As illustrated in FIG. 1, embodiments of the present invention provide new functionality through the mixture or combination of the physical input device (i.e., the physical keyboard) with the utility bar, which can be considered as an on-screen keyboard (OSK), an on-screen companion input device, or the like. Several types of input information that supplement written text are provided, including emoji, sticker, GIFs, and the like. Since this supplementary input information is not available on conventional keyboards, and would not be adjustable if provided in a keyboard implementation that includes emojis, embodiments of the present invention provide a curated, smart OSK that expands the capabilities that a conventional tablet and keyboard provide.

Embodiments of the present invention assist users with entry of both text and other symbols. By utilizing both a physical keyboard, which provides a plurality of fixed, physical data entry keys, and the touch-screen capabilities of the tablet, a seamless flow of inputs from the physical keyboard 110 and the utility bar 120 can be achieved. As described herein, the elements of the utility bar 120 can be populated based on inputs received through the physical keyboard. Thus, embodiments provide a utility bar, which can be positioned on the screen of the tablet adjacent or close to the physical keyboard, and together with physical keyboard, can be used for a wide variety of types of inputs that are richer and more intelligent than that provided using conventional techniques. As will be described in additional detail in subsequent sections, the utility bar is not limited to the display of emoji, but can be utilized to display letters, words, other types of text, richer emoji, stickers, graphic files such as GIFs, and the like. By providing the ability to display, and utilize as inputs, elements that are not available using conventional physical keyboards, the flexibility of the input process available to the user is increased. Additionally, software operating in conjunction with embodiments of the present invention can provide smart selections that enable the user to quickly select inputs form a pre-populated or pre-seeded list. One of ordinary skill in the art would recognize many variations, modifications, and alternatives.

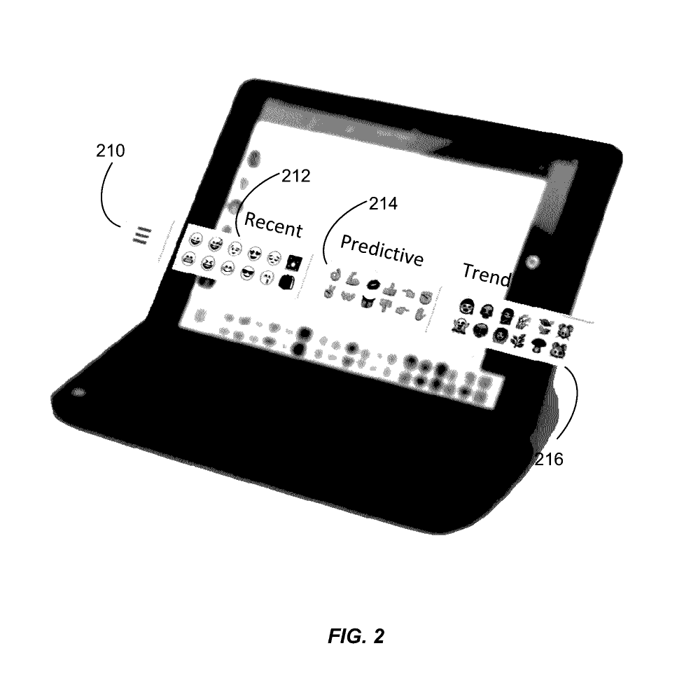

FIG. 2 illustrates an expanded view of a utility bar on a tablet computer physically and communicatively coupled to a physical keyboard, according to an embodiment of the invention. As shown in FIG. 2, the utility bar 120 includes a number of sections 210, 212, 214, and 216. These sections can vary in size, width and height, and can include a variety of elements that can be displayed on the screen. In the embodiment illustrated in FIG. 2, section 210 is an options menu (e.g., for configuring utility bar 120, selecting or modifying content, etc.), section 212 provides a set of emojis that have been utilized recently, section 214 provides a set of emojis that the system has predicted will be used by the user, and section 216 provides a set of emojis that are currently trending on social media, for example, over the duration of an hour, a day, a week, or the like. The multiple scrollable/interaction areas 210-216 provide display of the emojis based on the context of recent history (212), the context of the user's typing on the physical keyboard (214), and the context of emoji trends on the internet (216). In certain embodiments, an on-screen keyboard, virtual keyboard, and utility bar can be used interchangeably.

Although not illustrated in FIG. 2, the utility bar can include a section that includes one or more of the following: text, including letters and/or words, stickers, media including images and video, images such as GIFs, and a list of applications. As an example, the list of applications provided in a section of the utility bar can be used to switch between applications based on user input, thus providing direct and efficient app access. As another example, the content displayed in the sections can be personalized and context-aware, with content designed for interaction between the user and the tablet. For instance, as the user types a word, emoji, stickers, or GIFs related to the word can be provided in the utility bar.

The media, including emojis, that are displayed in the utility bar can be presented in response to user input, web trends, or the like. Predictive emojis can be based on the output of the physical keyboard and draw on a word suggestion lexicon. The predictive emoji can be based on simple word pairs, word-category pairs, history for the user, and the like. For example, typing “piz” could result in a predictive emoji illustrating a slice of pizza. Typing “Christm” could result in emoji related to the Christmas holiday season, including snowmen with Santa hats, and the like.

Trending emoji can be displayed based on trend analysis for internet searches. The inventors have determined that emoji demonstrate trending behaviors and the trending emoji displayed on the utility bar could be based on knowledge of these trends and presented to the user based on global trends, app specific trends, friend trends, celebrity usage trends, or the like. A top trending emoji can include a current most popular emoji, a set of most popular emoji (i.e., more than one), most popular emoji of a particular type (e.g., smiley emojis, celebrity emojis, etc.), and the like. Those of ordinary skill in the art would understand the many variations and possibilities with respect to top trending emojis.

Although emojis are illustrated in FIG. 2, embodiments of the present invention are not limited to the display of emojis in the utility bar and include a wide variety of rich media inputs, including audio, video, touch, and the like. Utilizing the physical keyboard to enter text, the utility bar provides a vehicle for a rich input experience that can include touch, visual, and audio inputs. As an example, an icon can be displayed that will enable the microphone of the tablet, enabling an audio clip to be added to a message. Similar functionality could be provided for the camera of the tablet.

As illustrated in FIGS. 1 and 2, the physical keyboard is the primary user input device for text input on the tablet. Based on the inputs provided to the tablet from the physical keyboard, the user experience is expanded to a much richer experience that includes touch, visual, and audio inputs through the tablet. Thus, the combination of a physical keyboard and the on-screen keyboard, responsive to inputs from the physical keyboard, enrich the user experience. In addition to the ability to access media through the touch-based interface of the tablet, audio and video inputs are available through the tablet. Embodiments provide the ability to store media that the user creates, provide a section including recently used media, and the like. As an example, if the user types a phrase on the physical keyboard that has been typed previously, media including emoji that have been used recently can be displayed in the recent section.

Referring to FIG. 1 again, touch input received through the tablet can be received by the user touching elements on the utility bar 120 or other portions of the screen. In some embodiments, hovering over a portion of the utility bar 120 will result in a zoom feature that magnifies the elements on the utility bar.

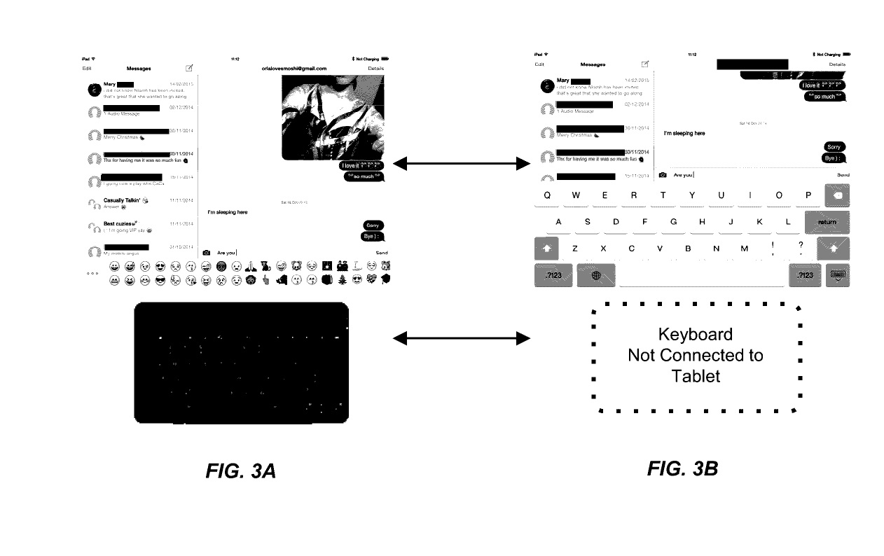

FIGS. 3A and 3B illustrate how a software application creates a seamless integration of physical and virtual input devices, according to certain embodiments of the invention. FIG. 3A illustrates how the keyboard is connected to the tablet, for example, through a Bluetooth or other suitable wireless or wired connection. When the keyboard and the tablet are connected, then the utility bar appears on the screen as appropriate to the particular application, providing a seamless on/off functionality. FIG. 3B illustrates how the keyboard and the utility bar can be disconnected. When the keyboard and the tablet are disconnected, the utility bar disappears and the screen returns to the regular functionality, for example, the virtual keyboard illustrated in FIG. 3B. Thus, embodiments of the present invention provide for seamless selection/deselection of the utility bar or other suitable OSK in sync with the status of the wireless or wired connection.

In some embodiments, a software application creates the seamless integration of physical and virtual input devices illustrated in FIGS. 3A and 3B. As illustrated, the companion OSK providing the virtual utility bar can appear/disappear automatically in synchronization with a Bluetooth connection. Manual operation is possible as well. For instance, a user can connect a wireless keyboard to a tablet device and manually select the OSK application through an operating system (OS) graphical user interface (GUI). For example, this may be done by a dedicated key on the keyboard.

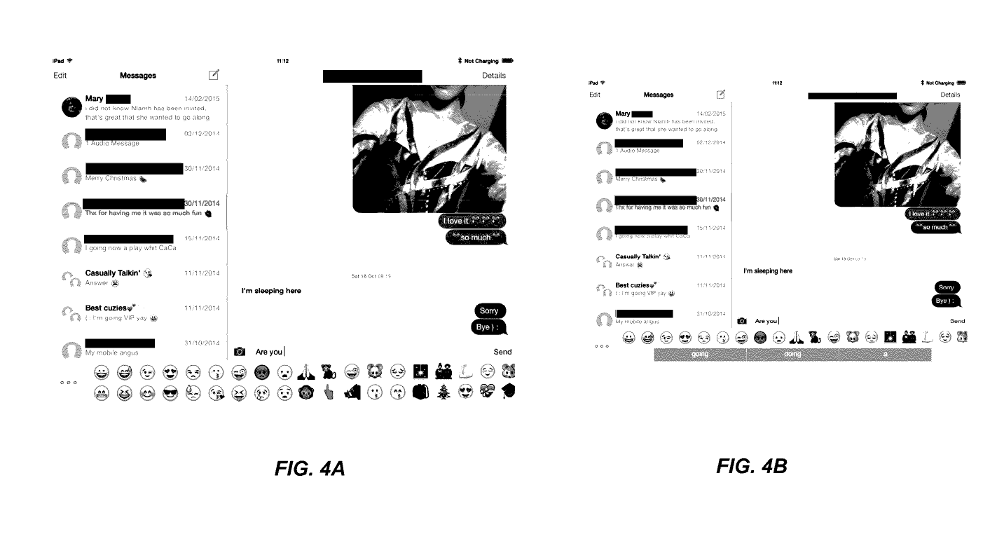

FIG. 4A illustrates a static scrollable on-screen keyboard, according to certain embodiments of the invention. Referring to FIG. 4A, the utility bar is displayed along the bottom of the tablet's screen. In this embodiment, the utility bar is a static, scrollable on-screen keyboard. The utility bar can be varying height, accommodating 1, 2, 3, 4, or more rows of elements such as emoji. A category button (not shown) can be used to bring up a listing of emoji categories, thereby providing for emoji category selection, as well as settings in some embodiments. The emoji or other elements displayed in the utility bar can include a full scrollable set of emoji including recently used emoji, predicted emoji, popular emoji, trending emoji, or the like. Other elements including graphics and images/videos can also be displayed. In some embodiments, emoji categories, for example, as defined in iOS, can be displayed, enabling the user to select the category of interest.

As illustrated in FIG. 4A, the utility bar can be a physical keyboard friendly version of standard OSK emoji that is optimized for use with an external keyboard, as shown for example in FIG. 1. FIG. 4B illustrates a static scrollable on-screen keyboard including one or more words, according to certain embodiments of invention. In this embodiment, both emoji predictions and word predictions are implemented in one or more zones of the utility bar. In this particular implementation, as the user utilizes the physical keyboard to type words, a lower portion of the utility bar is utilized to display predicted words that can be selected by the user. An upper portion of the utility bar is utilized to display emoji, which can be sorted by category, be predicted based on the text that the user is entering using the physical keyboard, or the like. Although this particular implementation of a user interface mixing text and emoji is illustrated, the present invention is not limited to this particular implementation and other embodiments can display multiple areas/zones for interaction according to certain embodiments of the invention.

In conventional keyboard/tablet implementations, the process to insert elements other than text in communications is not seamless. Typically, after some text is entered, the user selects the emoji or graphic icon, which then modifies the screen to provide emoji or graphics. These emoji or graphics can be searched to find the desired element, the user selects/copies the desired element, and then pastes the desired element into the text window. In contrast with this lengthy and cumbersome process, embodiments of the present invention enable a user to type in text using the physical keyboard and then add the desired elements from the utility bar by simply clicking on the desired element, seamlessly providing for data entry from the physical keyboard and the OSK.

As an example, a user may enter the text: “It is raining.” In response to this text entry, a set of emojis related to rain and inclement weather can be displayed on the utility bar. Additionally, a database of images/videos, including, for example, GIFs, stickers, or other images, either stored locally or remotely, can be searched so that a set of images can be displayed on the utility bar. The user can then select one these elements to append the sentence “It is raining.” In order to generate advertising revenue, an app designer can provide seeded expressions and elements. For instance, if the user enters text related to the weather, an umbrella with a product logo could be displayed as an emoji, an image of a person wearing a hat with a product logo could be displayed as a graphic, or the like. Personalization of the elements on the utility bar can also be implemented, enabling a user to create graphics or emoji that can be used in a personalized manner. One of ordinary skill in the art would recognize many variations, modifications, and alternatives.

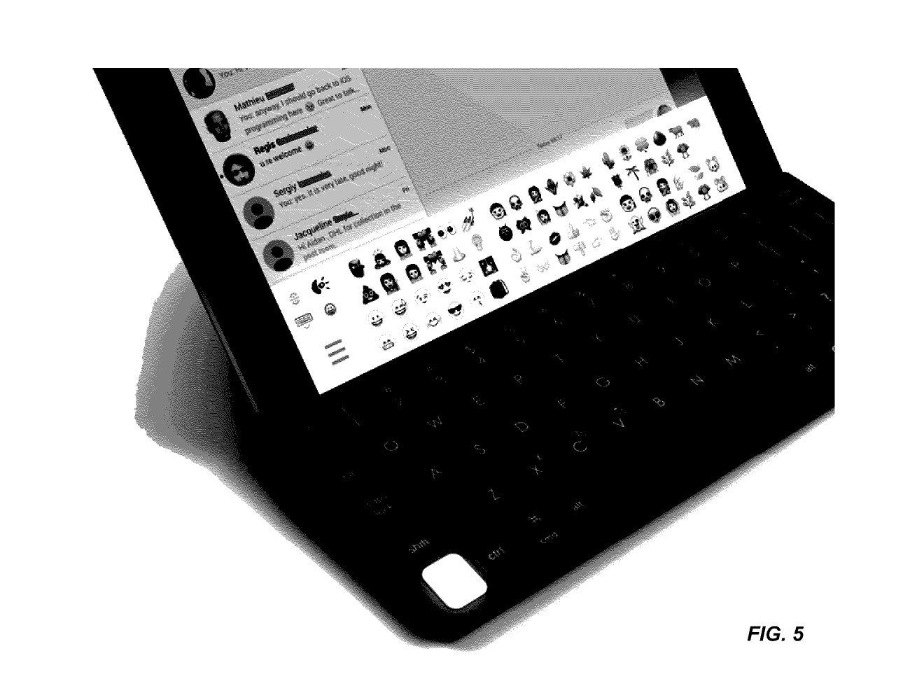

FIG. 5 shows a modifier key that can dynamically change the format of the on-screen keyboard, according to certain embodiments of the invention. As illustrated in FIG. 5, a keystroke input on the physical keyboard can enhance the on-screen keyboard, for example by increasing the number of rows of icons from two rows to four rows. In FIG. 5, when the user depresses the lower left key on the physical keyboard, the number of rows shown in the utility bar increases from two rows to four rows, thereby increasing the amount of content provided through the utility bar. Although the lower left key is illustrated in FIG. 5 as a modification key, other keys can be utilized to modify the format of the utility bar, including combinations of keys. Moreover, the number of rows of content in the utility bar can be greater than or less than four rows.

In some embodiments, a keystroke on the physical keyboard can be utilized to not only modify the number of rows of icons presented by the OSK, but to rearrange the order in which the icons are presented, expand a given section of the utility bar, or the like. As an example, although FIG. 2 illustrates the recent, predictive, and trending emojis from left to right, selection of a modification key on the physical keyboard can result in the order being adjusted or the size of a given section with respect to the other sections being increased or decreased.

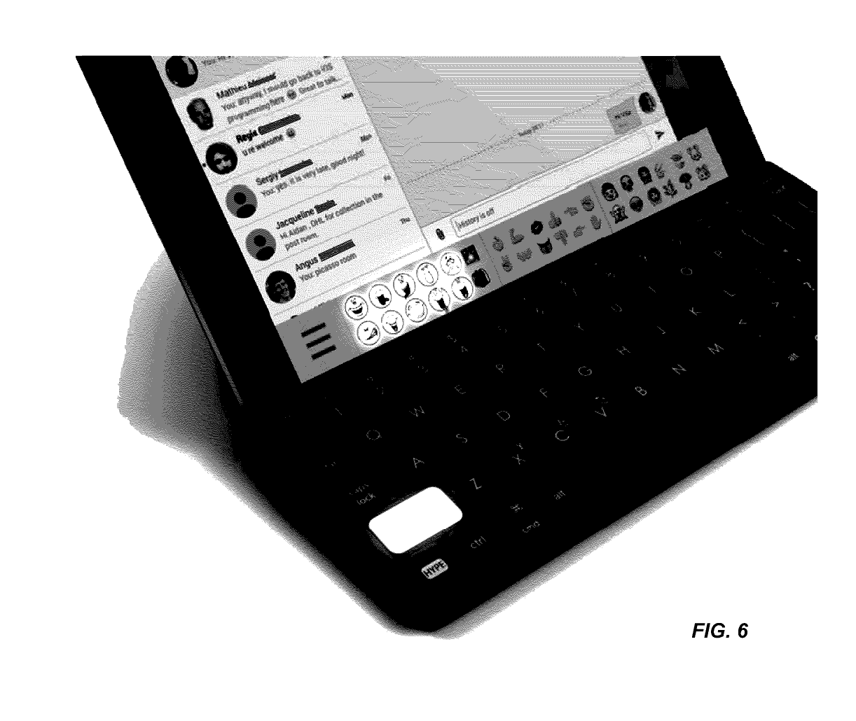

FIG. 6 illustrates use of a key on the physical keyboard to amplify media on the on-screen keyboard, according to certain embodiments of the invention. In the embodiment illustrated in FIG. 6, the shift key is used in an exemplary manner to “amplify” certain emoji by typing with capitals, thereby mixing the physical keyboard inputs and the virtual keyboard to amplify the media available for user input. Although the shift key is illustrated in FIG. 6, this is merely an example of how different keys can be utilized in different manners to enhance the interaction and user experience. In the example illustrated in FIG. 6, depressing the shift key on the physical keyboard modifies the media, e.g., emoji, displayed on the utility bar such that the displayed media are amplified versions of the initial media. As an example, if the recent emoji include a happy face emoji, the amplified version of the emoji shown in the recent emoji section could be a laughing face or the like. The feelings communicated by the emoji can thus be amplified, either by greater emotion or reduced emotion, based on the inputs from the physical keyboard. As another example, the up arrow or down arrow keys on the physical keyboard could be utilized to amplify or reduce the emotion of the particular emoji. One of ordinary skill in the art would recognize many variations, modifications, and alternatives.

In some embodiments, a second input device, such as a computer mouse, can cause the virtual keyboard to amplify certain media (e.g., emojis). Amplification can be used for a wide variety of applications beyond modifying emojis. For instance, “amplifying” may cause a change to a font (e.g., size, capitals, color, style), or may include customizing or modifying certain images, GIFs, avatars (e.g., amplify facial expression/posture, amplify speech synthesis, etc.), stickers (e.g., each successive sticker being increasingly exclamatory), and the like. In some cases, amplifying can have several stages or modes of operation. For instance, a first instantiation of “amplify” may cause a first outcome, and successive instantiations may cause additional levels of “amplification.” For example, amplifying a word in a utility bar (i.e., on the virtual keyboard) can cause the word to be displayed in all-caps. Amplifying again may cause the capitalized word to be displayed in a bolded font. A third amplification may cause the bolded and capitalized word to be displayed in a red font.

In certain embodiments, word suggestions can be amplified. For instance, “angry” can be a first suggestion, followed by “really angry,” “furious”, etc. In another example, a string of increasingly amplified word or acronym suggestions can include LQTM (laugh quietly to myself), LOL (laugh out loud), ROFL (rolling on the floor laughing), etc. One of ordinary skill in the art would recognize many variations, modifications, and alternatives.

Thus, as illustrated in FIGS. 5 and 6, the keys on the physical keyboard can be utilized to modify the content displayed on the virtual keyboard. In some implementations, the user is provided with the ability to re-purpose some standard non-modifier keys, e.g., the function keys to quickly show/hide more/less content in the virtual keyboard. For example, embodiments provide the ability for a user to define and access vendor-specific human interface device (HID) keys that can be useful to quickly show/hide more/less OSK content. The use of keystroke inputs on the physical keyboard to modify the OSK content is not limited to amplification of emojis. For example, the number keys on the physical keyboard can be utilized in conjunction with foreign languages (e.g., written in symbols, such as Asian languages) as inputs that are displayed on the virtual keyboard. The Asian language inputs can be associated with the number keys such that as a user enters text on the physical keyboard, Asian language word suggestions are presented on the virtual keyboard with a number associated with each word suggestion. By depressing the appropriate number key on the physical keyboard, the desired word can be inserted. This method reduces the need for the user to move their fingers to the touch screen to select the desired word using the touch functionality of the OSK.

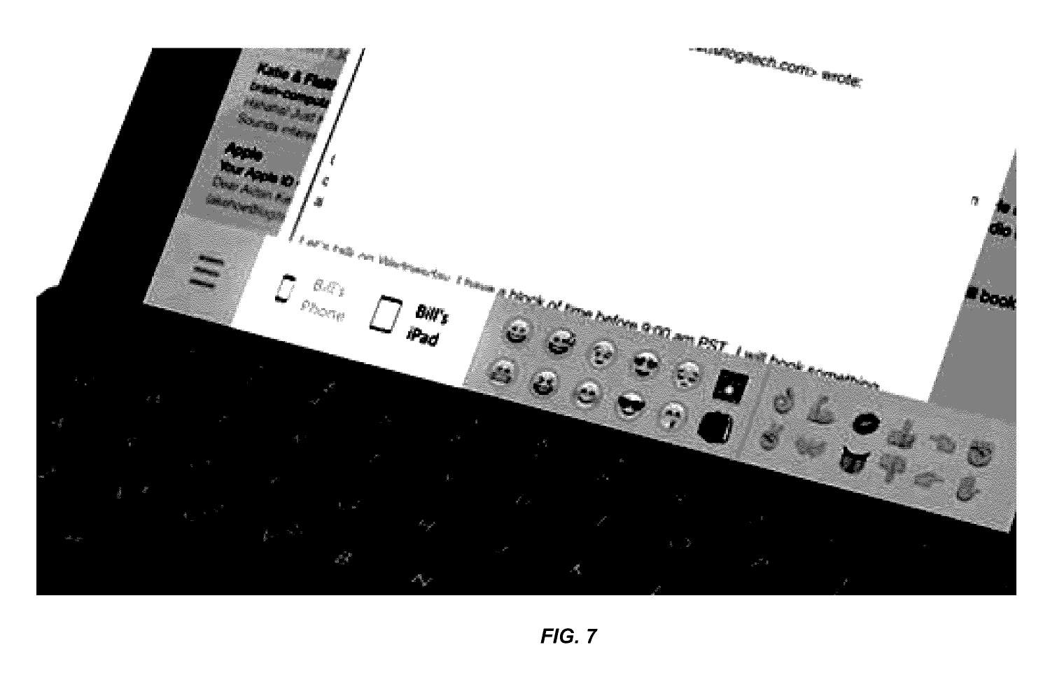

FIG. 7 illustrates an integrated user interface, according to certain embodiments of the invention. Referring to FIG. 7, an integrated user interface is provided that enables the physical keyboard to be utilized with multiple hosts and to optionally provide the user with power status information. The physical keyboard communicates information to the tablet so that the tablet can display the active host (e.g., Bill's iPad) and the available hosts (e.g., Bill's iPhone) on the virtual keyboard. In one implementation, the active host can be highlighted in comparison to the available hosts, displayed in different colors, or the like. Switching between hosts, which can be represented by names defined by the host or customized by the user, can be driven by inputs on the OSK. Thus, when the user taps on the icon associated with the available host, the physical keyboard will receive a signal and act to switch to the newly selected host and the OSK will update to show the newly selected host as the active host and the previously active host as an available host.

In some embodiments, in addition to information on the available and active hosts, the OSK can be utilized to display information on the status of the physical keyboard, including the battery status for the physical keyboard, low battery warnings, or the like. As illustrated in FIG. 7, the sections of the utility bar are adaptable and the content can be modified depending on the particular condition. In FIG. 7, a section of emojis has been replaced with a section providing information on the active and available hosts. Other sections can be modified, replaced, substituted, or the like according to various embodiments of the present invention. For instance, a section with power management information could be inserted on the utility bar.

According to some embodiments of the present invention, the look and feel of the physical and virtual keyboards are configured to provide a similar user experience. As an example, if the physical keyboard has a particular background color, for instance yellow, then the virtual keyboard could utilize the same background color to provide a substantially seamless look at the intersection of the physical keyboard and the virtual keyboard. The fonts/sizes that are utilized on the physical keyboard can be communicated to the tablet so that the tablet can use the same fonts/sizes for text displayed on the virtual keyboard. In addition, the key size and shape and other characteristics can be matched. In some embodiments, the background color for the media such as emoji displayed on the virtual keyboard can be matched to the background color of the physical keyboard for an integrated appearance. Thus, the user experience can be customized to provide a consistent look and feel as the user's eye transitions from the physical to virtual keyboards or vice versa.

In one implementation, the physical keyboard communicates information about the physical keyboard to the tablet to enable this matching of the color/texture and look of the physical and virtual components, thereby creating an integrated feel. The information about the physical keyboard can include color/shape/texture, layout/language, battery status, and the like. Given this information, an optimized/paired configuration is provided in which the virtual keyboard is “matched” to the physical keyboard. If, for example, the physical keyboard does not include a number row, the virtual keyboard can implement a number row as a bottom row of the utility bar, presenting the number row in the same color/font/etc. to enhance the functionality of the combined system integrating the physical and virtual keyboards. In some embodiments, the user experience is customized automatically to provide the same look and feel between the physical and virtual keyboards when the physical keyboard and the tablet are paired, whereas, in other embodiments, such customization is performed based on user inputs.

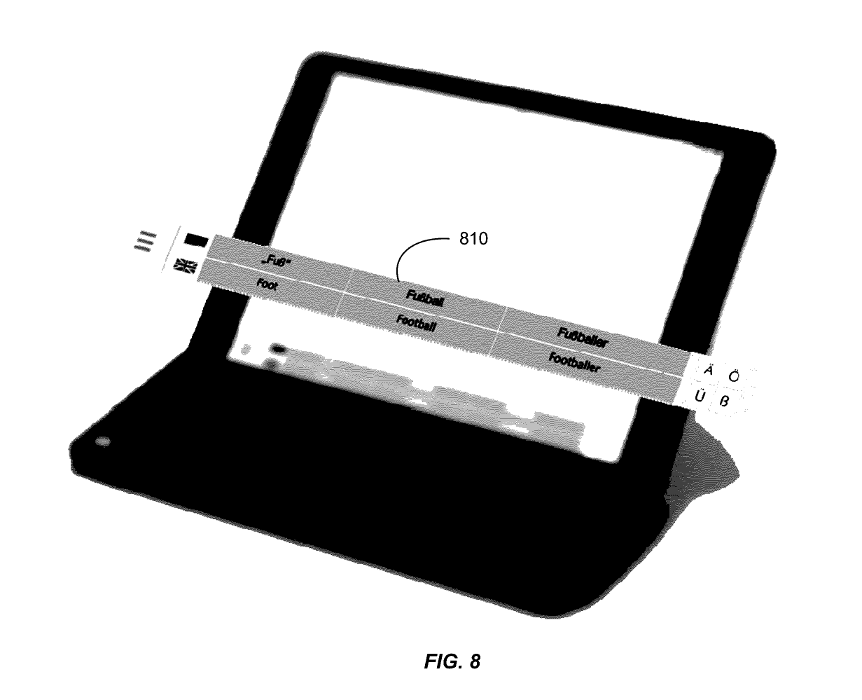

FIG. 8 illustrates an implementation that provides for bilingual virtual text and virtual emoji entry, according to certain embodiments of the invention. As illustrated in FIG. 8, the utility bar 810 is shown in an expanded view for purposes of clarity. The utility bar, which is displayed on the portion of the table adjacent the physical keyboard, includes two rows that show text in different languages. The ability to integrate text in multiple languages is thus provided by embodiments of the present invention, which is useful for people who are typing in different languages, for example, a bilingual document. In contrast with conventional systems that are primarily focused on one language keyboard, embodiments of the present invention provide multiple languages and language translation features through the interaction of the physical keyboard with the virtual keyboard.

In the example illustrated in FIG. 8, suggested text in English is shown on a first row and suggested text in German is shown on a second row. Icons indicating the language can be shown in conjunction with the text, for example, a flag representing the country associated with a particular language. In addition to suggested text, special characters for each language can be displayed on the virtual keyboard, improving the ease with which letters can be input.

Given the multi-language capability provided by embodiments of the present invention, not only suggested words and special characters can be provided to the user, but also other media that is country or language specific. For example, emojis can be displayed that are customized to particular languages, for instance, presenting a combination of text and emojis through the utility bar, thereby providing for both text entry and emoji interaction optimized for multi-language (e.g., dual-language) input. As the user types on the physical keyboard, the inputs received through the physical keyboard can be used to populate the virtual keyboard with multi-language translations, word suggestions, special characters, country-specific emojis, and the like. In a particular embodiment, as the user types in a first language on the physical keyboard, a translation of the input text can be generated and displayed on the virtual keyboard, providing not only for automated translation, but word predictions in multiple languages, including the first language.

In one implementation, information related to the physical keyboard can be utilized to display missing or special symbols on the virtual keyboard. For example, if a user is typing in German on an English keyboard, German language keys including the umlaut symbols and the eszett symbol can be shown on the virtual keyboard as the user types, thereby providing for entry in a second language via the virtual keyboard while using a physical keyboard designed for a first language.

Certain embodiments of the invention are directed to an optimized prediction bar on an OSK used in conjunction with a physical keyboard. A touch-enabled LCD on the keyboard may be too expensive in some configurations. Some of this functionality can be supported through an application-enabled “predictions/app switch” bar on the tablet screen.

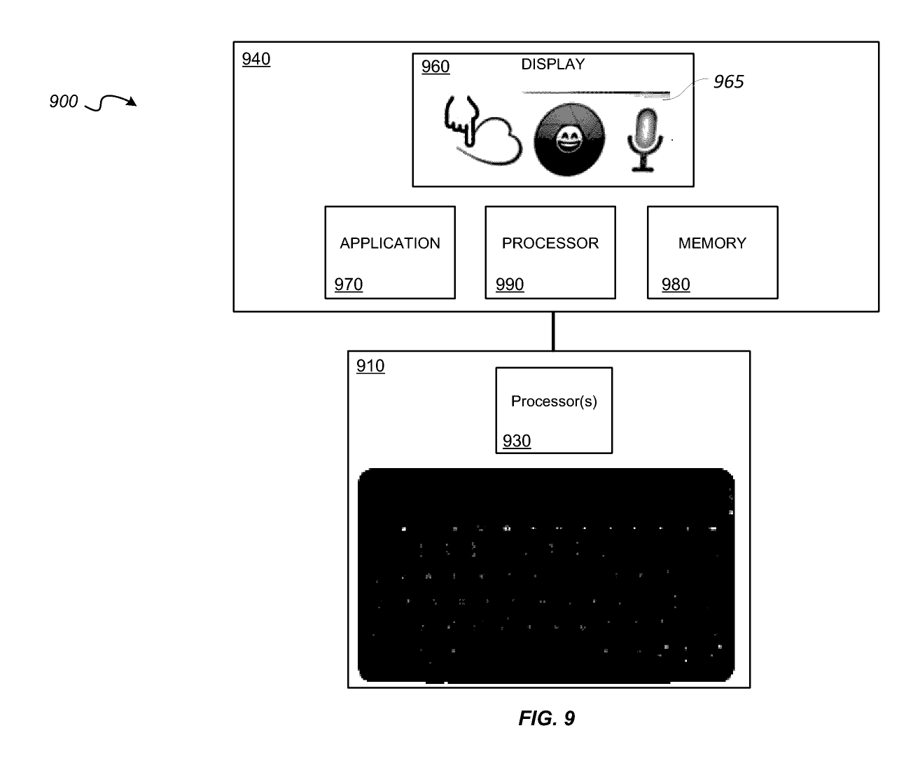

FIG. 9 is a system diagram 900 for displaying an on-screen virtual keyboard on a touch-sensitive display, according to certain embodiments. System diagram 900 includes physical input device 910 and computing device 940. Physical input device 910 can include any suitable peripheral device with a touch-sensitive display including a tablet cover (with a keyboard), keyboard, number pad, smart phone, computer mouse, touch pad, hybrid input device (combination of input methodologies), and the like, as would be appreciated by one of ordinary skill in the art. Computing device 940 can be any suitable computing device including a desktop computer, laptop computer, tablet computer, net book, smart phone, wearable technology (e.g., smart watch), or the like. Input device 910 can be in electronic communication with computing device 940. In FIG. 9, input device 910 can be a wireless keyboard 920 and processor 930, and computing device 940 can be a tablet computer, according to certain embodiments.

In some embodiments, input device 910 can include a number of physical keys disposed on keyboard 920 and, in conjunction with processor 930, can generate an output signal corresponding to a user pressing one or more of the physical keys, as would be understood by one of ordinary skill in the art. Input device 910 can generate any suitable output including numbers, letters, symbols, commands, macros, media (e.g., video and/or audio, GIFs, etc.), and the like. Processing unit(s) 930 can include a single processor, multi-core processor, or multiple processors and may execute instructions in hardware, firmware, or software. In some embodiments, input device 910 may not include an on-board processor.

Memory 980 can include various memory units such as a system memory, a read only memory (ROM), and permanent storage device(s) (e.g., magnetic, solid state, or optical media, flash memory, etc.). The ROM can store static data and instructions required by processing unit(s) 990 and other modules of the system 900 (e.g., application 970). The system memory can store some or all of the instructions and data that the processor needs at runtime.

Application 970 can be a software application that may be run by processor 990, according to some embodiments. Application 970 can perform the various embodiments of generating and controlling an on-screen virtual keyboard, as described, e.g., in methods 1000-1200, according to some implementations. Application 970 can operate on any suitable operating system, including but not limited to, Microsoft Windows, Mac OS, Apple iOS, Android, or the like.

System 900 can be used to implement the various embodiments described herein (e.g., FIGS. 1-8 and 10-12) and other tacitly embodied, but now shown, by the present disclosure. It should be understood that system 900 is a simplified version of a typical system and is not all-inclusive as certain systems, modules, or devices may have been left out such that the inventive concepts described herein are not obfuscated by too much detail. Those of ordinary skill in the art would understand the many variations, modifications, and alternative systems that may be applied.

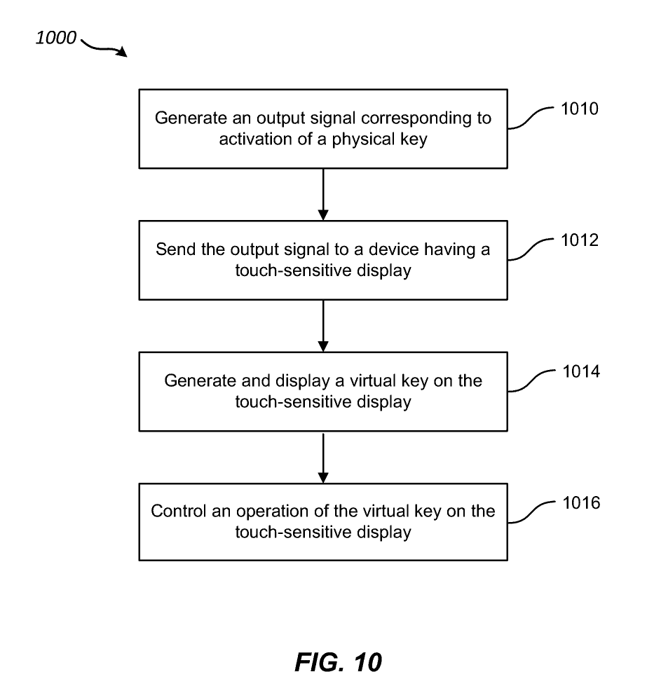

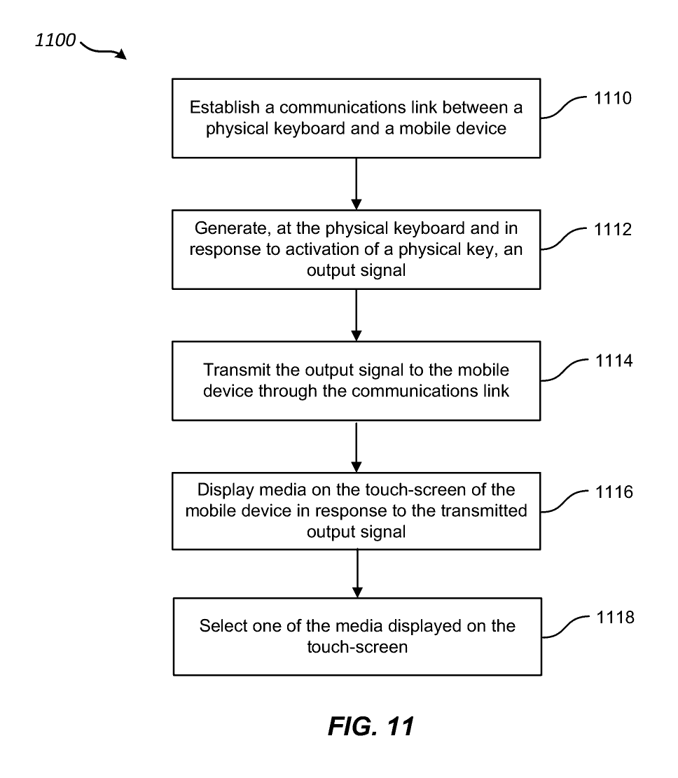

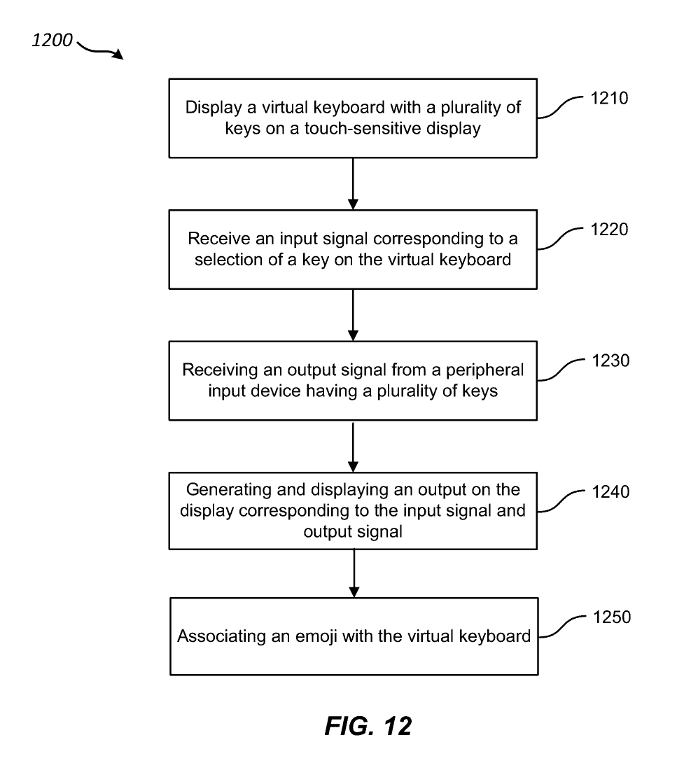

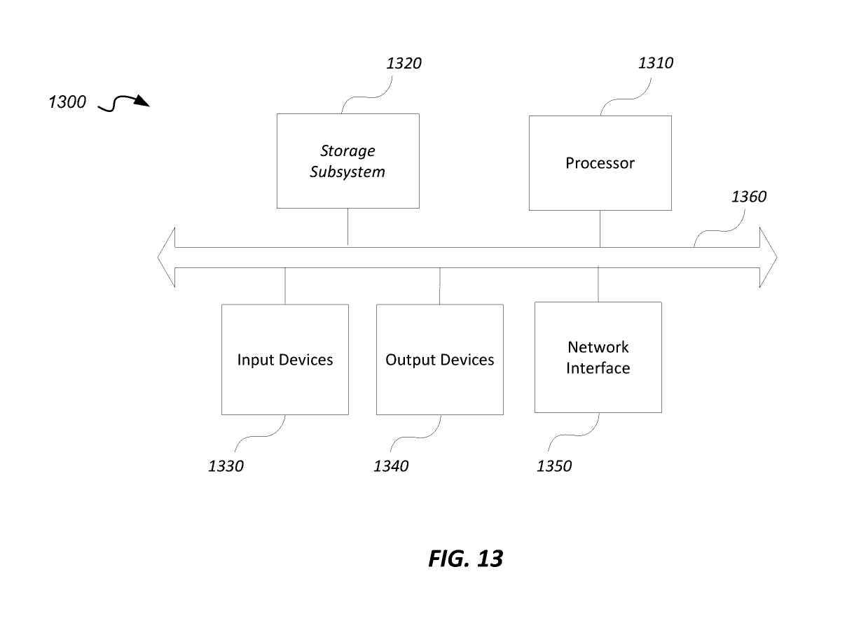

FIG. 10 is a simplified flowchart illustrating a method 1000 of generating a virtual keyboard on a display that corresponds with and operates in conjunction with a physical keyboard, according to an embodiment of the present invention. Method 1000 (as well as methods 1100-1200) can be performed by processing logic that may comprise hardware (circuitry, dedicated logic, etc.), software operating on appropriate hardware (such as a general purpose computing system or a dedicated machine), firmware (embedded software), or any combination thereof. In certain embodiments, methods 1000-1200 can be performed at least by the systems shown and described in FIGS. 9 and 13. In some embodiments, processor 930 of FIG. 9 may perform some or all of the operations described with respect to methods 1000-1100 of FIGS. 10-11. In further embodiments, processor 990 of FIG. 9 may perform some or all of the operations described with respect to methods 1200 of FIGS. 12.

At step 1010, method 1000 can include generating an output signal by an input device that corresponds to an activation of one or more physical keys on the input device, according to certain embodiments. For instance, this can include pressing a key on a physical keyboard and generating a corresponding alphanumeric output signal. Any output signal is possible including numbers, letters, symbols (e.g., emojis), commands, macros, etc. The input device can be a tablet cover, keyboard, number pad, smart phone, computer mouse, touch pad, hybrid input device, and the like, as would be appreciated by one of ordinary skill in the art.

At step 1020, method 1000 can include sending the output signal to a second input device having a touch-sensitive display, according to certain embodiments. For example, step 1020 may include sending an output signal from a physical keyboard to a tablet computer with a touch-sensitive display. The second input device can include any suitable computing device with a touch-sensitive display including a desktop computer, laptop computer, tablet computer, smart phone, wearable technology (e.g., smart watch), or the like.

At step 1030, method 1000 can include sending a control signal to generate and display a virtual keyboard including the one or more virtual keys on the touch-sensitive display, according to certain embodiments. The virtual keyboard can be of any suitable size, shape, or location on the display. In some embodiments, the virtual keyboard may be include multiple sections (e.g., a virtual keyboard on the bottom left of a display and a second virtual keyboard on the bottom right of the display). The virtual keyboard can include a number of additional virtual keys in addition to the one or more virtual keys corresponding to the activated one or more physical keys.

At step 1040, method 1000 can include controlling an operation of the virtual key displayed on the touch-sensitive display, where the physical key and the virtual key are concurrently operable. That is, both the physical key (e.g., from a physical keyboard) and the virtual key (e.g., on the virtual keyboard) can be accessed by a user at the same time (simultaneously or substantially simultaneously—i.e., contemporaneously).

As mentioned above, any output signal can be possible including numbers, letters, symbols, commands, macros, media (e.g., video and/or audio), etc. In some embodiments, method 1000 can include associating an emoji with the virtual key. The emoji can be a context specific emoji corresponding to at least a portion of a recently input word or phrase output by the input device. The emoji may include a top trending emoji on a social media platform, a recently used emoji, a predictive word or phrase corresponding to an output of the input device, or other output, as would be appreciated by one or ordinary skill in the art with the benefit of this disclosure.

In certain embodiments, method 1000 can further include determining a context of the emoji based on at least a portion of a recently input word or phrase output by the input device. That is, one or more emojis (or symbols) can be generated based on what a user is typing. For instance, if the user begins typing the word “pizza,” then emojis or symbols associated with pizza can be generated (e.g., a slice of pizza, a restaurant, coupons, advertisements, etc.). Once the context of the emoji or symbol is determined, method 1000 can further include generating a second control signal configured to generate and display a second virtual key on virtual keyboard of the touch-sensitive display, and associating a second emoji with the second virtual key, where the second emoji is related to the emoji based on the context of the emoji.

In some embodiments, method 1000 can further include receiving an input corresponding to an activation of an on/off key on the input device and generating a second output signal corresponding to the activation of an on/off key, according to certain embodiments. The generated second output signal can be sent to the input device to successively enable and disable the virtual key. In certain implementations, method 1000 can include controlling an aesthetic presentation of the virtual keys (and/or virtual keyboard) including a color scheme based on aspects of the input device. Other aesthetic qualities may be adjusted on the virtual keys and/or virtual keyboard including physical attributes of the input device (e.g., shape, graphical designs on the input device, advertisements or manufacturer's indicia, and the like).

It should be appreciated that the specific steps illustrated in FIG. 10 provide a particular method of generating a virtual keyboard on a display that corresponds with and operates in conjunction with a physical keyboard, according to an embodiment of the present invention. Other sequences of steps may also be performed according to alternative embodiments. For example, alternative embodiments of the present invention may perform the steps outlined above in a different order. Moreover, the individual steps illustrated in FIG. 10 may include multiple sub-steps that may be performed in various sequences as appropriate to the individual step. Furthermore, additional steps may be added or removed depending on the particular applications. One of ordinary skill in the art would recognize many variations, modifications, and alternatives.

FIG. 11 is a simplified method 1100 of operating a keyboard and a mobile device, according to an embodiment of the present invention. The method includes establishing a communications link between the physical keyboard and the mobile device, wherein the mobile device includes a touch-sensitive screen. The communications link may be a wireless communications link, for example, Bluetooth, or a wired communications link. In some implementations, the keyboard is operable to communicate with several different mobile devices, including tablets, mobile phones, and the like. The physical keyboard can include a docking element operable to receive the mobile device, with the touch-sensitive screen of the mobile device and the physical keyboard facing a user.

The method also includes generating, at the physical keyboard and in response to activation of a physical key by a user, an output signal associated with the activation of the physical key. The output signal may be one of a series of output signals generated as the user types using the physical keyboard. The method additionally includes transmitting the output signal to the mobile device through the communications link, for example, over Bluetooth.

The method further includes displaying a virtual keyboard on the touch-sensitive screen of the of the mobile device in response to the transmitted output signal. The virtual keyboard can include any suitable alphanumeric character, symbol, or media (audio or video link). In some cases, the virtual keyboard can include a set of emojis displayed on a portion of the touch-sensitive screen. The portion of the touch-sensitive screen may be divided into sections that provide display space for groups of emojis, including recently used emojis, predictive emojis, and the like. Based on the output signals from the physical keyboard, which may be considered as input signals to the mobile device, the media displayed on the screen can be varied depending on the particular application. For example, as the user type letters, the processor of the mobile device can process the received letters and suggest words that can then be displayed, and selected, using the touch-screen. Thus, embodiments of the present invention provide for an interaction between the physical keyboard and the touch-screen of the mobile device that expand the functionality provided by these elements independently.

It should be appreciated that the specific steps illustrated in FIG. 11 provide a particular method of operating a keyboard and a mobile device, according to an embodiment of the present invention. Other sequences of steps may also be performed according to alternative embodiments. For example, alternative embodiments of the present invention may perform the steps outlined above in a different order. Moreover, the individual steps illustrated in FIG. 11 may include multiple sub-steps that may be performed in various sequences as appropriate to the individual step. Furthermore, additional steps may be added or removed depending on the particular applications. One of ordinary skill in the art would recognize many variations, modifications, and alternatives.

FIG. 12 is a simplified flowchart illustrating a method 1200 of displaying a virtual keyboard on a touch-sensitive display, according to an embodiment of the present invention. At step 1210, method 1200 can include displaying, by a processor, a virtual keyboard having a plurality of keys on a touch-sensitive display, according to certain embodiments. The virtual keyboard can be of any suitable size, shape, or location on the display, or may be comprised of multiple sections and may include any suitable computing device with a touch-sensitive display including a desktop computer, laptop computer, tablet computer, smart phone, wearable technology (e.g., smart watch), or the like.

At step 1220, method 1200 can include receiving, by the processor, an input signal corresponding to a selection of at least one of the plurality of keys on the virtual keyboard, according to certain embodiments. For example, a user may physically press a virtual key (or keys) on a touch-sensitive display (e.g., on a tablet computer).

At step 1230, method 1200 can include receiving by the processor, an output signal from a peripheral input device having a plurality of keys, according to certain embodiments. The output signal can correspond to a key press on one or more of the plurality of keys. The peripheral device can be a tablet cover (e.g., with one or more keys), keyboard, number pad, smart phone, computer mouse, touch pad, hybrid input device, and the like, as would be appreciated by one of ordinary skill in the art.

At step 1240, method 1200 can include generating and displaying, by the processor, an output on the touch-sensitive display corresponding to the input signal and output signal, according to certain embodiments. The output on the touch-sensitive display can be an alphanumeric character (in any language), a symbol, an emoji, a word, a phrase, a string of characters, media (video, audio, etc.), or other type of output on the virtual keyboard. In some embodiments, the processor concurrently displays the virtual keyboard, processes and displays data associated with the input signal in the displayed output, and processes and displays data associated with the output signal in the displayed output.

At step 1250, method 1200 can further include associating an emoji with the virtual keyboard, according to certain embodiments. The emoji can be context specific and may correspond to at least a portion of a recently input word or phrase output by the peripheral input device. In some cases, the emoji can be a top trending emoji on a social media platform, or may be a recently used emoji. The virtual keyboard can include a selectable predictive word or phrase corresponding to a recently input word or phrase output by the peripheral input device (or the virtual keyboard), according to certain embodiments.

In some embodiments, method 1200 can include receiving, by the processor, a second output signal corresponding to the activation of an on/off key on the peripheral input device, and enabling or disabling the virtual keyboard in response to receiving the second output signal. In further implementations, method 1200 can include controlling an aesthetic presentation of the virtual keyboard including a color scheme based on metadata received from the peripheral input device, according to certain embodiments. Other aesthetic qualities may be adjusted on the virtual keys and/or virtual keyboard as discussed above with respect to FIG. 10.

It should be appreciated that the specific steps illustrated in FIG. 12 provide a particular method of displaying a virtual keyboard on a touch-sensitive display, according to an embodiment of the present invention. Other sequences of steps may also be performed according to alternative embodiments. For example, alternative embodiments of the present invention may perform the steps outlined above in a different order. Moreover, the individual steps illustrated in FIG. 12 may include multiple sub-steps that may be performed in various sequences as appropriate to the individual step. Furthermore, additional steps may be added or removed depending on the particular applications. One of ordinary skill in the art would recognize many variations, modifications, and alternatives.

It is also understood that the examples and embodiments described herein are for illustrative purposes only and that various modifications or changes in light thereof will be suggested to persons skilled in the art and are to be included within the spirit and purview of this application and scope of the appended claims.

FIG. 13 illustrates a simplified representation of a computer system 1300 for generating and controlling a virtual keyboard, according to certain embodiments. The software (e.g., heat mapping software, peripheral controller, secondary display controllers, etc.), systems, and methods described herein (e.g., FIGS. 1-12) can be implemented within or in conjunction with a computer system such as computer system 1300 shown here, as would be understood by one of ordinary skill in the art with the benefit of this disclosure. Computer system 1300 can be implemented as any type of computing devices, including, e.g., server(s), a desktop or laptop computer, a tablet computer, a smart phone, a personal digital assistant (PDA), or any other type of computing device, not limited to any particular form factor. Computer system 1300 can include processing unit(s) 1310, a storage subsystem 1320, input devices 1330 (e.g., keyboards, mice, touchscreens, etc.), output devices 1340 (e.g., displays, speakers, tactile output devices, etc.), a network interface 1350 (e.g., RF, 4G, EDGE, WiFi, GPS, Ethernet, etc.), and a bus 1360 to communicatively couple the various elements of system 1300 to one another. In some embodiments, output device(s) 1340 can include the touch sensitive display, as described above with respect to FIGS. 1-12.

Processing unit(s) 1310 can include a single processor, multi-core processor, or multiple processors and may execute instructions in hardware, firmware, or software, such as instructions stored in storage subsystem 1320. The storage subsystem 1320 can include various memory units such as a system memory, a read only memory (ROM), and permanent storage device(s) (e.g., magnetic, solid state, or optical media, flash memory, etc.). The ROM can store static data and instructions required by processing unit(s) 1310 and other modules of the system 2400. The system memory can store some or all of the instructions and data that the processor needs at runtime. In some embodiments, processing unit(s) 1310 can include processor 990 of FIG. 9.

In some embodiments, storage subsystem 1320 can store one or more of data or software programs to be executed or controlled by processing unit(s) 1310, such as the OSK software (e.g., application 970), as further described above with respect to FIGS. 1-12. As mentioned, “software” can refer to sequences of instructions that, when executed by processing unit(s) 1310, cause computer system 1300 to perform certain operations of the software programs. The instructions can be stored as firmware residing in read only memory and/or applications stored in media storage that can be read into memory for processing by processing unit(s) 1310. Software can be implemented as a single program or a collection of separate programs and can be stored in non-volatile storage and copied in whole or in part to volatile working memory during program execution. From storage subsystem 1320, processing unit(s) 1310 can retrieve program instructions to execute in order to execute various operations (e.g., interpolations) described herein. In certain embodiments, system 1300 can perform some or all of the operations described above with respect to FIGS. 1-12.

It will be appreciated that the computer system 1300 is illustrative and that variations and modifications are possible. Computer system 1300 can have other capabilities not specifically described here in detail. Further, while computer system 1300 is described with reference to particular blocks, it is to be understood that these blocks are defined for convenience of description and are not intended to imply a particular physical arrangement of component parts. Further, the blocks need not correspond to physically distinct components. Blocks can be configured to perform various operations, e.g., by programming a processor or providing appropriate control circuitry, and various blocks might or might not be reconfigurable depending on how the initial configuration is obtained. Embodiments of the present invention can be realized in a variety of apparatus including electronic devices implemented using any combination of circuitry and software.

Aspects of system 1300 may be implemented in many different configurations. In some embodiments, system 1300 may be configured as a distributed system where one or more components of system 1300 are distributed over one or more networks in the cloud.

While the invention has been described with respect to specific embodiments, one of ordinary skill in the art will recognize that numerous modifications are possible. Thus, although the invention has been described with respect to specific embodiments, it will be appreciated that the invention is intended to cover all modifications and equivalents within the scope of the following claims.

It should be understood that terms such as “input device,” “peripheral device,” and the like, are used interchangeably throughout this document and are not limiting.

The above disclosure provides examples and aspects relating to various embodiments within the scope of claims, appended hereto or later added in accordance with applicable law. However, these examples are not limiting as to how any disclosed aspect may be implemented.

All the features disclosed in this specification (including any accompanying claims, abstract, and drawings) can be replaced by alternative features serving the same, equivalent or similar purpose, unless expressly stated otherwise. Thus, unless expressly stated otherwise, each feature disclosed is one example only of a generic series of equivalent or similar features.

Any element in a claim that does not explicitly state “means for” performing a specified function, or “step for” performing a specific function, is not to be interpreted as a “means” or “step” clause as specified in 35 U.S.C. §112(f). In particular, the use of “step of” in the claims herein is not intended to invoke the provisions of 35 U.S.C. §112(f).

What is claimed is:

1. An input device comprising:
a housing;
a plurality of physical keys disposed in the housing; and
a processor to:
i) generate an output signal in response to one of the plurality of physical keys being activated; and
ii) control an operation of one or more virtual keys displayed on a touch-sensitive display, the physical keys and the one or more virtual keys configured for concurrent operation.

2. The input device of claim 1 wherein the processor is further configured to communicate with a software application operating on the touch-sensitive display and control a selection of the one or more virtual keys based on features of the software application.

3. The input device of claim 1 wherein the one or more virtual keys includes one or more emojis.

4. The input device of claim 3 wherein the one or more emojis includes a context specific emoji corresponding to at least a portion of a recently input word or phrase on the plurality of physical keys.

5. The input device of claim 1 wherein the one or more emojis includes trending emojis associated with a social media platform.

6. The input device of claim 1 wherein the one or more emojis includes a second set of emojis dynamically generated in response to a selection of a first emoji, the second set of emojis contextually related to the first emoji.

7. The input device of claim 1 wherein the one or more emojis includes recently used emojis.

8. The input device of claim 1 wherein the one or more virtual buttons includes one or more function keys.

9. The input device of claim 1 wherein the one or more virtual keys includes predictive words or phrases corresponding to an input on the plurality of physical keys.

10. The input device of claim 1 wherein the plurality of physical keys includes a key to enable and disable the one or more virtual keys.

11. The input device of claim 1 wherein the processor is further configured to control an aesthetic presentation of the virtual keys including a color scheme.

12. A method of operating an input device, the method comprising:
generating, by a processor, an output signal corresponding to an activation of one or more physical keys on the input device;
sending, by the processor, the output signal to a second input device having a touch-sensitive display;
sending a control signal, by the processor, to generate and display a virtual keyboard including a virtual key on the touch-sensitive display; and
controlling an operation of the virtual key displayed on the touch-sensitive display, wherein the physical key and the virtual key are concurrently operable.

13. The method of claim 12 further comprising associating an emoji with the virtual key.

14. The method of claim 13 wherein the emoji is a context specific emoji corresponding to at least a portion of a recently input word or phrase output by the input device.

15. The method of claim 14 further including:
determining a context of the emoji based on at least a portion of a recently input word or phrase output by the input device;
generating a second control signal, by the processor, configured to generate and display a second virtual key on the touch-sensitive display; and
associating a second emoji with the second virtual key, wherein the second emoji is related to the emoji based on the context of the emoji.

16. The method of claim 12 wherein the emoji is a top trending emoji on a social media platform.

17. The method of claim 12 wherein the emoji is a recently used emoji.

18. The method of claim 12 wherein the virtual key includes a predictive word or phrase corresponding to an output of the input device.

19. The method of claim 12 further comprising:
receiving an input corresponding to an activation of an on/off key on the input device;
generating, by the processor, a second output signal corresponding to the activation of an on/off key;
sending the second output signal to the input device, wherein the second output signal successively enables and disables the virtual key.

20. The method of claim 12 further comprising:
controlling an aesthetic presentation of the virtual keys including a color scheme based on aspects of the input device.

21. A method comprising:
displaying a virtual keyboard having a plurality of keys on a touch-sensitive display;
receiving, by a processor, an input signal corresponding to a selection of at least one of the plurality of keys on the virtual keyboard;
receiving, by the processor, an output signal from a peripheral input device having a plurality of keys; and
generating and displaying an output on the touch-sensitive display corresponding to the input signal and output signal,
wherein the processor concurrently:
(i) displays the virtual keyboard;
(ii) processes and displays data associated with the input signal in the displayed output; and
(iii) processes and displays data associated with the output signal in the displayed output.

22. The method of claim 21 further comprising associating an emoji with the virtual keyboard.

23. The method of claim 22 wherein the emoji is context specific and corresponds to at least a portion of a recently input word or phrase output by the peripheral input device.

24. The method of claim 22 wherein the emoji is a top trending emoji on a social media platform.

25. The method of claim 22 wherein the emoji is a recently used emoji.

26. The method of claim 21 wherein the virtual keyboard includes a selectable predictive word or phrase corresponding to a recently input word or phrase output by the peripheral input device.

27. The method of claim 22 further comprising:
receiving, by the processor, a second output signal corresponding to the activation of an on/off key on the peripheral input device; and
enabling or disabling the virtual keyboard in response to receiving the second output signal.

28. The method of claim 22 further comprising:
controlling an aesthetic presentation of the virtual keyboard including a color scheme based on metadata received from the peripheral input device.
